(19) United States
(12) Patent Application Publication
(10) Pub. No.: US 2019/0204684 A1
(43) Pub. Date: Jul. 4, 2019

(54) BACKLIGHT UNIT AND DISPLAY DEVICE HAVING THE SAME

(71) Applicant: SAMSUNG DISPLAY CO., LTD., Yongin-si (KR)

(72) Inventors: Byung Seo Yoon, Hwaseong-si (KR); Kyu Tae Park, Hwaseong-si (KR); Ju Young Yoon, Seoul (KR); Seung Pyo Hong, Hwaseong-si (KR)

(21) Appl. No.: 16/195,936

(22) Filed: Nov. 20, 2018

(30) Foreign Application Priority Data
Jan. 2, 2018 (KR) 10-2018-0000172

(51) Int. Cl. G02F 1/1335; G02F 1/1333

(52) U.S. Cl. CPC G02F 1/133606; G02F 1/133308

(57) ABSTRACT

A backlight unit includes a light source, a mold frame which accommodates the light source includes at least a first sidewall and an inclined surface protruding and sloping downward from an inner side surface of the first sidewall. A second sidewall may extend from the inclined surface in which the second sidewall is arranged substantially parallel to the first sidewall and has a space therebetween. The support member is disposed on the inclined surface of the mold frame. An optical plate may be disposed on an upper surface of the support member, and the optical plate and the inclined surface of the mold frame define an optical path in a space there between.

### CROSS-REFERENCE TO RELATED APPLICATION(S)

This application claims the benefit of Korean Patent Application No. 10-2018-0000172, filed on Jan. 2, 2018, in the Korean Intellectual Property Office, the disclosure of which is incorporated by reference herein in its entirety.

### TECHNICAL FIELD

Embodiments of the inventive concept relate to a backlight unit having a mold frame in which at least part of the mold frame has an inclined surface, and a display device having the same.

### DISCUSSION OF THE RELATED ART

With the development of multimedia technology, the demand for display devices used to access multimedia is becoming increasingly popular. Display devices may be categorized into self-luminous display devices, which emit light by themselves, and light-receiving display devices, which utilize a light source. Examples of the light-receiving display devices include a liquid crystal display device, an electrophoretic display device, and an electrowetting display device.

A light-receiving display device may include a display panel which controls the transmittance of incident light and a backlight unit which provides light to the display panel.

Backlight units are classified into a direct type and an edge type according to the position of a light source. In the case of the edge type backlight unit, a light source is disposed on one side of a light guide plate. In the case of the direct type backlight unit, the light source is disposed under a display panel. In a direct type backlight unit, an optical plate, for example, a diffusion plate, is disposed on a light emitting diode (LED) light source and may increase the diffusion of light emitted from the LED light source to illuminate various area of the display panel.

### SUMMARY

Embodiments of the inventive concept provide a backlight unit with a reduction in non-uniform luminance.

Embodiments of the inventive concept also provide a display device with enhanced display quality.

However, a person of ordinary skill in the art should understand and appreciate that embodiments of the inventive concept are not restricted to the ones set forth herein. The above and other embodiments the inventive concept will become better-appreciated by a person of ordinary skill in the art to which the embodiments of the inventive concept pertains by referencing the detailed description provided herein below.

According to an embodiment of the inventive concept, there is provided a backlight unit that includes a light source, a mold frame which accommodates the light source, the mold frame includes at least a first sidewall; a support member disposed on the mold frame, wherein the mold frame further includes an inclined surface protruding and sloping downward from an inner side surface of the first sidewall, and the support member is disposed on the inclined surface of the mold frame

According to an embodiment of the inventive concept, there is provided a multi-display device that includes a plurality of display devices arranged in an M×N matrix in a first direction. and a second direction substantially perpendicular to each other, wherein each one of the plurality of display devices comprises a display panel; and a backlight unit disposed under the display panel, wherein the backlight unit comprises: a light source including a plurality of lights; a mold frame which accommodates the light source and the mold frame includes a first sidewall that extends downward and an inclined surface protruding and sloping downward from an inner side surface of the first sidewall, and a second sidewall that extends downward from the inclined surface of the mold frame, wherein the second sidewall is arranged substantially parallel to the first sidewall and having a space therebetween; a support member disposed on the mold frame; and an optical plate disposed on the support member, wherein and the support member is disposed on the inclined surface of the mold frame.

According to an embodiment of the inventive concept, a reflective sheet is disposed under the light source to reflect light in an upward direction, and a second sidewall that extends downward from the inclined surface of the mold frame, wherein the second sidewall is arranged substantially parallel to the first sidewall and having a space therebetween.

According to an embodiment of the inventive concept, an optical plate is disposed on the upper surface of the support member, and the optical plate and the inclined surface of the mold frame define an optical path in a space there between.

### BRIEF DESCRIPTION OF THE DRAWINGS

Those and/or other embodiments of the inventive concept will be more readily appreciated from the following description of the embodiments, taken in conjunction with the accompanying drawings in which:

FIG. 1 is a perspective view of a display device according to an embodiment of the inventive concept;

FIG. 2 is a cross-sectional view taken along the line II-II′ of FIG. 1;

FIG. 3 is a partial perspective view of a mold frame and a support member according to an embodiment of the inventive concept;

FIG. 4 is a cross-sectional view of a display device according to an embodiment of the inventive concept;

FIG. 5 is a partial perspective view of a mold frame and a support member of the display device of FIG. 4;

FIG. 6 is a cross-sectional view of a display device according to an embodiment of the inventive concept;

FIG. 7 is a partial perspective view of a mold frame and a support member of the display device of FIG. 6;

FIG. 8 is a cross-sectional view of a display device according to an embodiment of the inventive concept;

FIG. 9 is a partial perspective view of a mold frame and a support member of the display device of

FIG. 10 is a cross-sectional view of a display device according to an embodiment of the inventive concept;

FIG. 11 is a partial perspective view of a mold frame and a support member of the display device of FIG. 10;

FIG. 12 is a graph illustrating luminance measured at an edge portion of a display device according to embodiments of the inventive concept;

FIGS. 13 and 14 are cross-sectional views of display devices according to embodiments;

FIGS. 15 and 16 are cross-sectional views of display devices according to embodiments of the inventive concept; and

FIGS. 17 and 18 are a perspective view and a plan view of a multi display device according to an embodiment of the inventive concept.

### DETAILED DESCRIPTION

In the following description, for the purposes of explanation, numerous specific details are set forth to provide a thorough understanding of various exemplary embodiments of the inventive concept. However, a person of ordinary skill in the art should understand and appreciate that that various embodiments of the inventive concept may be practiced without these specific details, or with one or more equivalent arrangements. In other instances, well-known structures and devices are shown in block diagram form may avoid unnecessarily obscuring various exemplary embodiments with unnecessary explanation of well-known structures and devices. Further, various embodiments of the inventive concept may be different from each other, but do not have to be exclusive. For example, specific shapes, configurations, and characteristics of an embodiment may be implemented in another embodiment without departing from the spirit and the scope of the disclosure.

Unless otherwise specified, the illustrated embodiments are to be understood as providing features of varying detail of some embodiments of the inventive concept. Therefore, unless otherwise specified, the features, components, modules, layers, films, panels, regions, etc. (hereinafter individually or collectively referred to as “elements”), of the various illustrations may be otherwise combined, separated, interchanged, and/or rearranged without departing from the spirit and the scope of the disclosure.

With regard to the drawings, the use of cross-hatching and/or shading in the accompanying drawings is generally provided to clarify boundaries between adjacent elements. As such, neither the presence nor the absence of cross-hatching or shading conveys or indicates any preference for particular materials, material properties, dimensions, proportions, commonalities between illustrated elements, and/or any other characteristic, attribute, property, etc., of the elements. Further, in the accompanying drawings, the size and relative sizes of elements may be exaggerated for clarity and/or descriptive purposes. When an embodiment of the inventive concept may be implemented differently than shown and described, a specific process order may be performed differently from the described order. For example, two consecutively described processes may be performed substantially at the same time or performed in an order opposite to the described order. Also, like reference numerals denote like elements.

When an element is referred to as being “on,” “connected to,” or “coupled to” another element, it may be directly on, connected to, or coupled to the other element or intervening elements may be present. When, however, an element is referred to as being “directly on,” “directly connected to,” or “directly coupled to” another element, there are no intervening elements present. To this end, the term “connected” may refer to physical, electrical, and/or fluid connection. For the purposes of this disclosure, “at least one of X, Y, and Z” and “at least one selected from the group consisting of X, Y, and Z” may be construed as X only, Y only, Z only, or any combination of two or more of X, and Z, e.g., for instance, XYZ, XYY YZ, and ZZ. As used herein, the term “and/or” includes any and all combinations of one or more of the associated listed items.

Although the terms “first,” “second,” etc. may be used herein to describe various elements, these elements should not be limited by these terms. These terms are used to distinguish one element from another element. Thus, a first element discussed below could be termed a second element without departing from the teachings of the disclosure.

Spatially relative terms, for example, “beneath,” “below,” “under,” “lower,” “above,” “upper,” “over,” “higher,” “side” (e.g., as in “sidewall”), and the like, may be used herein for descriptive purposes, and, thereby, to describe one element's relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments of the inventive concept and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms (e.g., “substantially perpendicular”), are used as terms of approximation and not as terms of degree, and, as such, are utilized to account for inherent deviations in measured, calculated, and/or provided values that would be recognized by one of ordinary skill in the art.

Various embodiments of the inventive concept are described herein with reference to sectional and/or exploded illustrations that are schematic illustrations of idealized embodiments of the inventive concept and/or intermediate structures. As such, variations from the shapes of the illustrations as a result, for example, of manufacturing techniques and/or tolerances, are to be expected. Thus, the embodiments of the inventive concept disclosed herein should not be construed as limited to the particular illustrated shapes of regions, but are to include deviations in shapes that result from, for instance, manufacturing. Accordingly, regions illustrated in the drawings are schematic in nature and Shapes of these regions may not illustrate the actual shapes of regions of a device, and, as such, are not limiting to the appended claims.

Unless otherwise defined, all terms (including technical and scientific terms) used herein have the same meaning as commonly understood by one of ordinary skill in the art to which this disclosure is a part. Terms, for example, those defined in commonly used dictionaries, should be interpreted as having a meaning that is consistent with their meaning in the context of the relevant art as understood by a person of ordinary skill and will not be interpreted in an idealized or overly formal sense, unless expressly so defined herein.

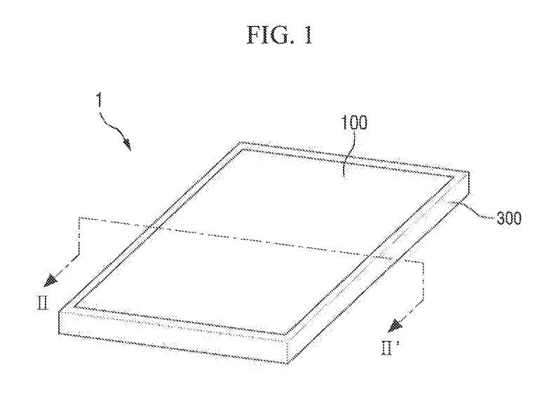

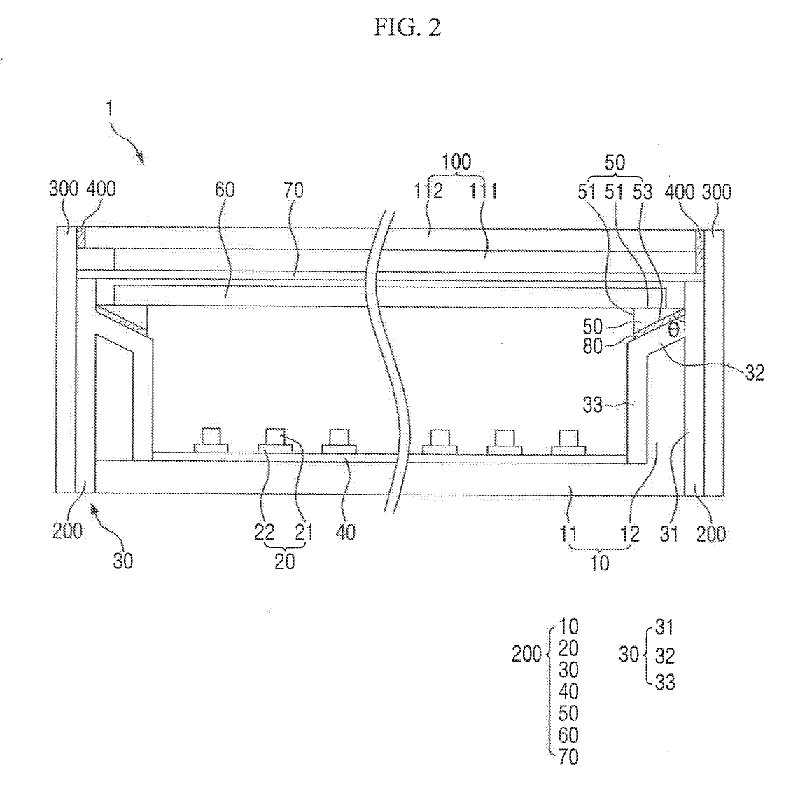

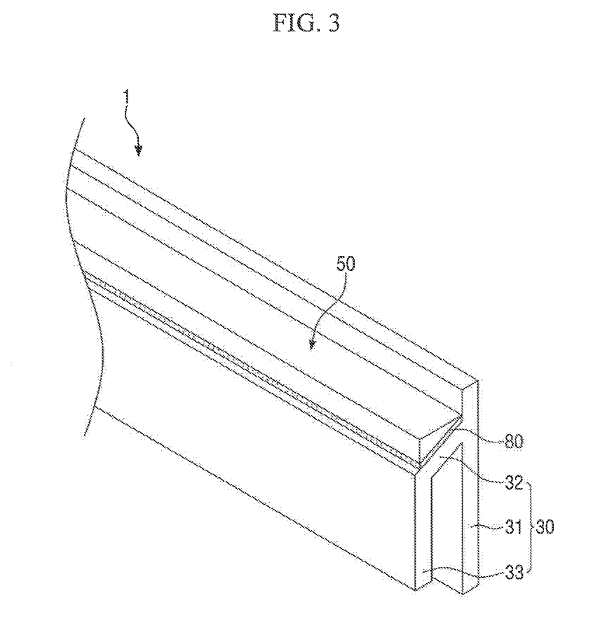

FIG. 1 is a perspective view of a display device 1 according to an embodiment of the inventive concept. FIG. 2 is a cross-sectional view taken along the line II-II′ of FIG. 1. FIG. 3 is a partial perspective view of a mold frame 30 and a support member 50 according to the embodiment shown in FIG.1.

Referring to FIGS. 1 through 3, the display device I may include a display panel 100, a backlight unit 200, and a top cover 300.

The display panel 100 may be a panel that displays an image. The display panel 100 receives light from the backlight unit 200 and displays a screen. Examples of such a light-receiving display panel that receives light and displays a screen include a liquid crystal display panel, an electrowetting display panel, an electrophoretic display panel, and a micro electro mechanical system (MEMS) display panel. Although a liquid crystal display panel is described herein as an example of the display panel 100, various other light-receiving display panels can be applied to the embodiments of the inventive concept.

The display panel 100 may include a first substrate 111, a second substrate 112, and a liquid crystal layer (not shown) disposed between the first substrate 111 and the second substrate 112. The first substrate 111 and the second substrate 112 overlap each other. In an embodiment of the inventive concept, any one of the first substrate 111 and the second substrate 112 may be larger than the other substrate to protrude further out. For example, the second substrate 112 disposed on the first substrate 111 may be larger than the first substrate 111 and protrude from a side of the first substrate 111. A protruding area of the second substrate 112 may provide a space in which a driver IC or an external circuit board is mounted. Alternatively, the first substrate 111 disposed under the second substrate 112 may be larger than the second substrate 112 and protrude further out than the first substrate 111.

With reference to FIG. 2, the backlight unit 200 is disposed under the display panel 100. The backlight unit 200 provides light to the display panel 100. Unless otherwise defined, the terms “above” and “upper surface” used herein denote a display surface side of the display panel 100, and the terms “under” and “lower surface” used herein denote an opposite side of the display panel 100 from the display surface side.

The backlight unit 200 includes a plurality of light source units 20, each of which includes light sources 21 mounted on a printed circuit board 22, a reflective sheet 40 which reflects light emitted from the light sources 21, and an optical plate 60 and an optical sheet layer 70 which control optical characteristics of the emitted

The light source units 20 may include, for example, a plurality of point light sources or linear light sources. The point light sources may be a light emitting diode (LED) light sources 21. The light sources 21 may be mounted on a printed circuit board 22.

The reflective sheet 40 is disposed under the light sources units 20 to reflect light, which is emitted downward from the light sources 21, in an upward direction toward the display panel 100.

With further reference to the backlight unit 200 shown in FIG. 2, the optical plate 60 and the optical sheet layer 70 are disposed above the light sources units 20. The optical plate 60 may be a diffusion plate for diffusing light incident from the light sources units 20. However, the optical plate 60 is not limited to being embodied as the diffusion plate and may be, for example, a wavelength conversion plate for converting the wavelength of light incident from the light source units 20. The wavelength conversion plate may include wavelength conversion particles and/or diffusion particles. The optical sheet layer 70 diffuses, polarizes, or concentrates incident light. The optical sheet layer 70 may be a combination of two or more optical sheets having at least one of the above functions. Some non-limiting examples of optical sheets that can be combined include a prism film, a diffusion film, a micro-lens film, a lenticular film, a polarizing film, a reflective polarizing film, and a retardation film. The optical sheet layer 70 may additionally include a protective sheet.

The backlight unit 200 may also include a bottom cover 10 and the mold frame 30 for housing or accommodating the light source units 20, the reflective sheet 40, the optical plate 60 and the optical sheet layer 70 described above.

The bottom cover 10 may be open on one side and includes a bottom surface 11 and a plurality of sidewalls 12 connected to the bottom surface 11. The light source units 20 and the reflective sheet 40 may be accommodated in a space defined by the bottom surface 11 and the sidewalls 12. Each sidewall 12 of the bottom cover 10 may be inserted and fixed into a space between a first sidewall 31 and a second sidewall 33 of the mold frame 30 to be subsequently described herein,

With reference to FIG. 3, the mold frame 30 is shaped like an integrated window frame having an opening in the middle. In other words, an integrated window frame typically has two or more windows attached to the frame with a space separating glazing legs (U.S. Pat. No. 6,266,288 shows some nonlimiting examples of an actual integrated window frame) that are substantially parallel to each other. The mold frame 30 may include the first sidewall 31, an inclined surface 32 sloping downward from an upper part of the first sidewall 31, and the second sidewall 33 extending from the inclined surface 32. The first sidewall 31 and the second sidewall 33 of the molding frame are substantially parallel. For example, the second sidewall 33 may be arranged substantially parallel to the first sidewall 31 and have a space therebetween. While the second sidewall 33 may extend from the inclined surface, a person of ordinary skill in the art understands and appreciates that the inclined surface, which protrudes from the first sidewall, may be disposed on an upper surface of the second sidewall instead of the second sidewall 33 extending from the inclined surface. A lower side of the mold frame 30 is open, and an empty space is formed in an area surrounded by the first sidewall 31, the inclined surface 32 and the second sidewall 33. Each sidewall 12 of the bottom cover 10 may be inserted into the empty space as described above.

With reference to FIG. 2 and FIG. 3, the inclined surface 32 of the mold frame 30 protrudes from a position spaced downwardly apart from an upper surface of the first sidewall 31 by a predetermined distance. The first sidewall 31 of the mold frame 30 may be divided into the upper part and a lower part based on the protrusion of the inclined surface 32. The optical plate 60 may be disposed in a space defined by the upper part of the first sidewall 31, the inclined surface 32, and the support member 50, that will be described in more detail hereinafter.

The inclined surface 32 of the mold frame 30 and the optical plate 60 may not be in direct contact with each other, and an empty space may be formed between the inclined surface 32 of the mold frame 30 and the optical plate 60. By arranging the inclined surface 32 of the mold frame 30 and the optical plate 60 to have an empty space, an optical path may be formed. Accordingly, light emitted from the light sources 21 may travel toward an edge of the display panel 100 through this empty space. Thus, by disposing the optical plate on the upper surface of the support member and defining a space between the optical plate and the inclined surface of the mold plate, the backlight unit may define an optical path in a space there between to eliminate/or reduce dark portions along a display panel being illuminated by the backlight unit.

For example, due to the inclined surface 32 of the mold frame 30 extending from the first sidewall 31 with a downward slope instead of extending substantially perpendicular to the first sidewall 31, the luminance of the edge portion of the display panel 100 can be increased. More specifically, a surface (not shown) of the mold frame 30 were to be disposed perpendicular to the first sidewall 31 and parallel to the bottom surface 11 of the bottom cover 10, light emitted from the light sources 21 may be interfered with by such a surface, particularly around the edge portions of the display panel. As a result, the amount of light reaching the edge portion of the display panel 100 may be reduced. In such a case, the edge portion of the display panel 100 may have a lower luminance than a central portion, and there may be a dark portion may be formed at the edge portion. On the other hand, in some embodiments of the inventive concept such as shown in FIG. 2 and FIG. 3, the inclined surface 32 of the mold frame 30 slopes downward from the first sidewall 31, light emitted from the light sources 21 can travel toward the edge portion of the display panel 100 along the inclined surface 32 without being interfered with by the inclined surface 32. This light traveling toward the edge portion of the display panel 100 along the inclined surface 32 can increase the luminance uniformity of the display panel 100 and reduce dark portions at the edge portion of the display panel 100.

As a downward inclination angle θ (FIG. 2) of the inclined surface 32 decreases, the empty space between the inclined surface 32 and the optical plate 60 increases. Accordingly, more light can pass through the empty space to be incident on the edge portion of the display panel 100. However, if the downward inclination angle θ of the inclined surface 32 is too small, it may be difficult to fix the support member 50 which will be described later. In this regard, the downward inclination angle θ of the inclined surface 32 may range from about 30 to 60 degrees with respect to the first sidewall 31.

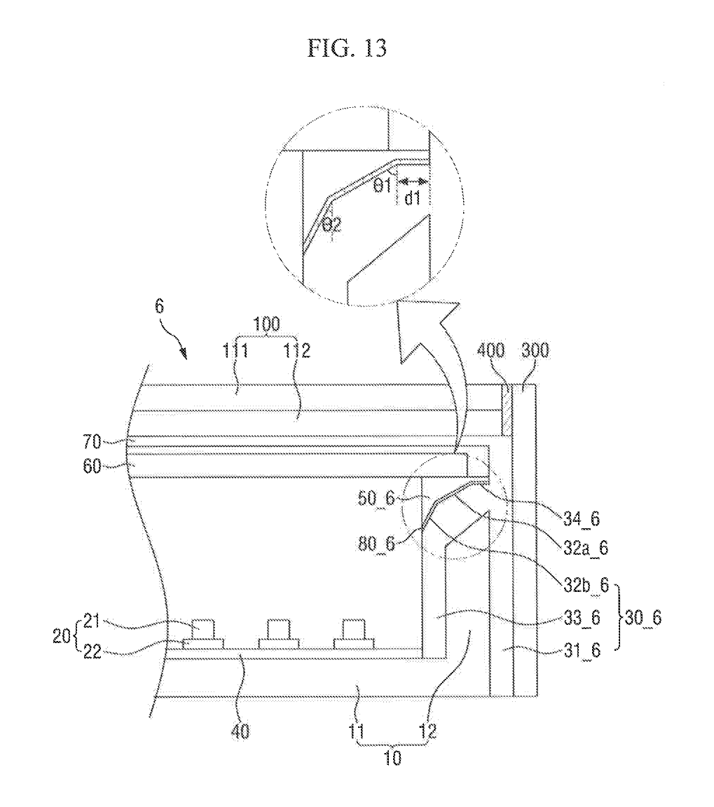

Although the inclined surface 32 of the mold frame 30 is illustrated as one plane in the drawings, it is not limited to one plane. For example, the inclined surface 32 of the mold frame 30 can be composed of two different planes as illustrated in FIG. 13, or can be a curved surface,

The support member 50 is disposed on the inclined surface 32 of the mold frame 30 to provide support to the optical plate 60. Since the inclined surface 32 of the mold frame 30 slopes downward from the first sidewall 31, it is difficult for the inclined surface 32 to secure a sufficient surface to support the optical plate 60, particularly in embodiments when the optical plate 60 is not in direct contact with the mold frame 30. The support member 50 complements the inclined surface 32 of the mold frame 30, so that the optical plate 60 can be stably supported. An upper surface 51 of the support member 50 is perpendicular to the first sidewall 31 and parallel to the bottom surface 11 of the bottom cover 10. Therefore, the upper surface 51 of the support member 50 provides a sufficient surface to support the optical plate 60,

As can be seen in FIG. 3, the support member 50 may be shaped like a triangular prism and extends in the same direction as the direction in which the inclined surface 32 of the mold frame 30 extends. However, the specific shape of the support member 50 is not limited to the above example, as the support member 50 may be any shape that may support the optical plate 60 to be secured. A case where the support member 50 is shaped like a triangular prism will hereinafter be described as an example.

A cross-section of the support member 50 is shaped like a right-angled triangle and may include, for example, the upper surface 51, a side surface 52 extending perpendicularly to the upper surface 51, and an inclined surface 53. The upper surface 51 may be perpendicular to the first sidewall 31 and parallel to the bottom surface 11 of the bottom cover 10 as described above. The upper surface 51 of the support member 50 is located below the upper surface of the first sidewall 31 of the mold frame 30. A distance between the upper surface 51 of the support member 50 and the upper surface of the first sidewall 31 may be equal to or greater than a thickness of the optical plate 60 such that an upper surface of the optical plate 60 disposed on the support member 50 does not protrude above the first sidewall 31.

A thickness of the support member 50 may increase as the distance from the first sidewall 31 of the mold frame 30 increases. As the support member 50 may complement the inclined surface 32 of the mold frame 30, this increase in thickness of the support member 50 as the distance from the first sidewall 31 of the mold frame 30 is shown in FIG. 3. For example, the inclined surface 53 of the support member 50 and the inclined surface 32 of the mold frame 30 may have the same inclination angle.

The side surface 52 of the support member 50 may be aligned with an inner side surface of the second sidewall 33, or may be disposed further out than the inner side surface of the second sidewall 33. Here, the inner side surface of the second sidewall 33 denotes a side surface disposed relatively closer to the central portion of the display device 1 among two side surfaces of the second sidewall 33. If the side surface 52 of the support member 50 is disposed further in than the inner side surface of the second sidewall 33 of the mold frame 30, the path of light may be unnecessarily interfered with by the support member 50. Therefore, in an embodiment of the inventive concept, the side surface 52 of the support member 50 may not be disposed further in than the inner side surface of the second sidewall 33. However, embodiments of the inventive concept are not limited to this arrangement. For example, the side surface 52 of the support member 50 may be disposed further in than the inner side surface of the second sidewall 33. In this case, the support member 50 may include scattering particles to assist in the diffusion of light.

The support member 50 may be made of a transparent or semi-transparent material to transmit light emitted from the light sources 21 toward the display panel 100. For example, the support member 50 may be made of polymethylmethacrylate (PMMA), PC, PET, or the like.

The support member 50 may include scattering particles. The scattering particles may guide light to the edge portion where the amount of light is relatively small by changing the propagation angle of light emitted from the light sources 21. The scattering particles may he made of silicon, TiO2, SiO2, ZnO, ZrO2, AlO2, Al, Ag, or a combination of the same. However, the material that forms the scattering particles is not limited to the above examples, and the scattering particles can be made of various materials having scattering properties, It is also within the embodiments of the inventive concept that the scattering particles may be not be uniformly distributed on the surface of the support member 50, in which some portions of the support member may guide light differently. In addition, the support member 50 may have, instead of scattering particles, a surface including grooves to scatter the Fight in a particular angle. In addition, the grooves may be formed to scatter the light at a different angle along respective surface areas of the support member 50.

When the optical plate 60 is a diffusion plate, a diffusion rate of the optical plate 60 may he greater than that of the support member 50. If the diffusion rate of the support member 50 is excessively high, the amount of light reaching the edge portion of the display panel 100 may be reduced because the light diffuses to other portions of the display panel 100 instead of traveling to the edge portion of the display panel 100.

The support member 50 may be fixed to the inclined surface 32 of the mold frame 30 by a joining member 80. The joining member 80 may include a polymer resin, an adhesive, or an adhesive tape that may have adhesion or adhesiveness on both sides, such as a double-sided tape. However, embodiments of the inventive concept are not limited to the aforementioned examples of a joining member 80, and the support member 50 may be formed by bi-injection and fixed to the mold frame 30 without a joining member.

With reference to FIG. 2, the optical sheet layer 70 may be disposed on the upper surface of the first sidewall 31 of the mold frame 30. A space may be formed between the optical plate 60 and the optical sheet layer 70 because the upper surface of the first sidewall 31 is spaced apart from the upper surface 51 of the support member 50.

The top cover 300 may be shaped, for example, like a quadrilateral frame with open upper and lower surfaces. The top cover 300 covers outer side surfaces of the mold frame 30 and covers the side surfaces of the display panel 100. However, the top cover 300 does not cover edges of an upper surface of the display panel 100. Since the entire upper surface of the display panel 100 is exposed to the outside, a bezel area can be minimized.

The display panel 100 may be disposed adjacent to upper parts of sidewalls of the top cover 300 and may be joined to the upper parts of the sidewalls of the top cover 300 by a panel joining member 400. The panel joining member 400 may include a polymer resin, an adhesive, or an adhesive tape. The panel joining member 400 can prevent light from leaking through the edge portion of the display panel 100 by performing a light blocking function. For example, the panel joining member 400 may include a light absorbing material, for example, a black pigment or a dye, or may include a reflective material.

Hereinafter, mold frames and support members according to embodiments of the inventive concept will be described. In the following embodiments of the inventive concept, a description of elements identical to those of the above-described embodiment will be omitted or simplified, and differences from the above-described embodiment will be mainly described.

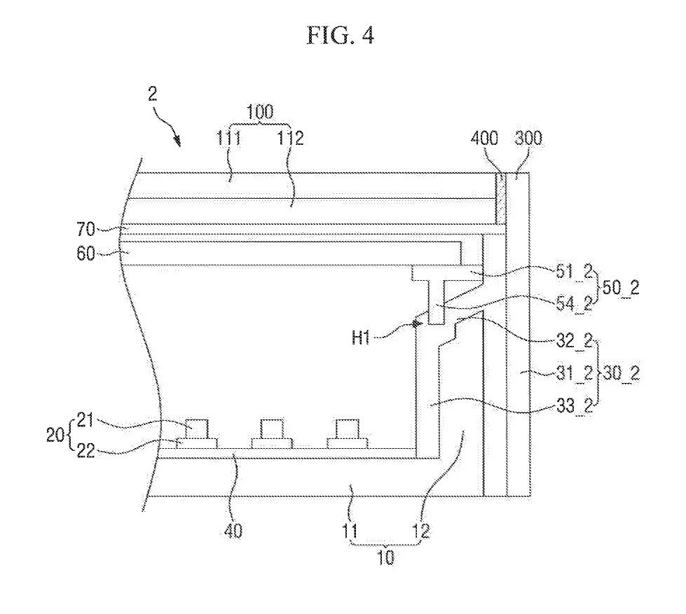

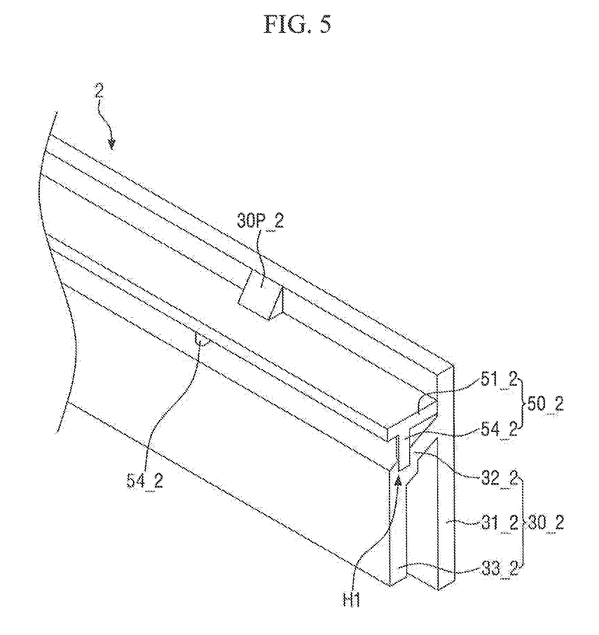

FIG. 4 is a cross-sectional view of a display device 2 according to an embodiment of the inventive concept. FIG. 5 is a partial perspective view of a mold frame 30_2 and a support member 50_2 of the display device 2 of FIG. 4.

FIGS. 4 and 5 show that the support member 50_2 of the display device 2 has a structure that can be inserted and fixed into the mold frame 30_2 without a joining member.

As in the embodiment of FIGS. 2 and 3, an upper surface 51_2 of the support member 50_2 is perpendicular to a first sidewall 31_2 of the mold frame 30_2 and parallel to a bottom surface 11 of a bottom cover 10. The upper surface 51_2 of the support member 50_2 can stably support an optical plate 50 arranged at least partially thereon.

The mold frame 30_2 may further include a fixing portion 30P_2 protruding inward from an inner side surface of the first sidewall 31_2. The fixing portion 30P_2 is disposed on an upper part of the first sidewall 31_2 and becomes wider from an upper surface of the first sidewall 31_2 toward a lower surface. A lower surface of the fixing portion 301_2 contacts the upper surface 51_2 of the support member 502, to help affix the support member 50_2.

The support member 50_2 includes a fixing portion ⁵⁴_2 protruding downward from the upper surface 51_2. There may be a plurality of fixing portions 54_2, and the fixing portions 54_2 may be arranged at regular intervals along a long side of the upper surface, 51_2. The fixing portion 54_2 may be disposed at a position relatively farther from the first side wall 31_2 of the mold frame 30_2 than the center of gravity of the upper surface 51_2 of the support member 50_2 along a direction in which a short side of the upper surface 51_2 of the support member 50_2 is disposed.

Although the fixing portion 54_2 is illustrated in the drawing as being cylindrical, the shape of the fixing portion 54_2 is not limited to the cylindrical shape. The fixing portion 54_2 can have various shapes, for example, a square pillar arid a triangular prism are just two of various shapes.

The fixing portion 54_2 may be inserted and affixed into a first groove formed in an inclined surface 32_2 of the mold frame 30_2. The first groove H1 may be recessed downward from the inclined surface 32_2 of the mold frame 30_2 and has a shape corresponding to the shape of the fixing portion 54_2 of the support member 50_2. For example, when the fixing portion 54_2 of the support member 50_2 is cylindrical, the first groove H1 of the mold frame 30_2 may also be cylindrical.

With continued reference to FIG. 5, a size of the fixing portion 54_2 of the support member 50_2 corresponds to a size of the groove H1 of the mold frame 30_2. For example, the size of the first groove H1 of the mold frame 30_2 is similar to the size of the fixing portion 54_2 of the support member 50_2 but may be larger than the size of the fixing portion 54_2 so that the fixing portion 54_2 can be inserted into the first groove H1.

The inclined surface 32_2 of the mold frame 30_2 and the upper surface 51_2 of the support member 50_2 may be spaced apart from each other by a predetermined distance, and an empty space may be formed between the inclined surface 32_2 of the mold frame 30_2 and the upper surface 51_2 of the support member 50_2. Light emitted from light sources 21 may pass through this empty space and enter an edge portion of a display panel 100 via the upper surface 51_2 of the support member 50_2. Since the area of the support member 50_2 disposed between the light sources 21 and the edge portion of the display panel 100 is minimized, it is possible to reduce light loss and increase the amount of light reaching the edge portion of the display panel 100. Accordingly, embodiments of the inventive concept can increase the luminance uniformity of the display panel 100 and reduce dark portions front occurring at each edge portion.

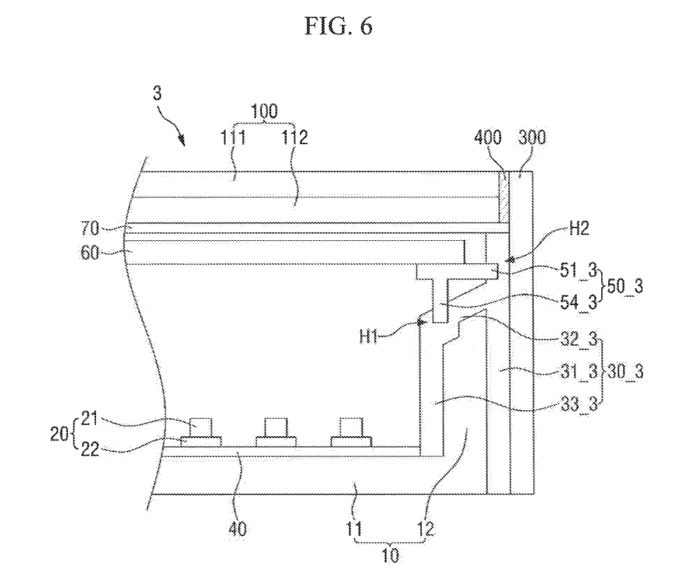

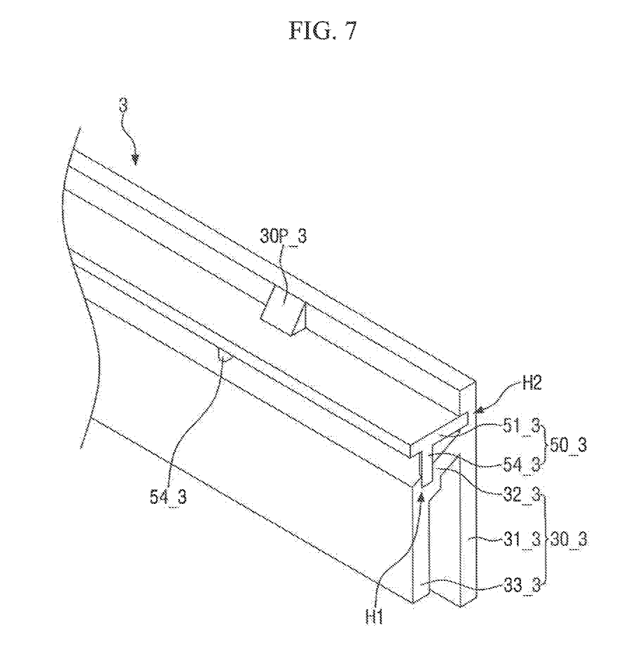

FIG. 6 is a cross-sectional view of a display device 3 according to an embodiment of the inventive concept. FIG. 7 is a partial perspective view of a mold frame 30_3 and a support member 50_3 of the display device 3 of FIG. 6.

The display device 3 of FIGS. 6 and 7 differs from the display device 2 of FIGS. 4 and 5 in that the mold frame 30_3 of the display device 3 includes a second groove H2 into which an upper surface 51_3 of the support member is inserted and fixed.

The second groove H2 is formed in a first sidewall 31_3 of the mold frame 30_3. The second groove H2 is recessed outward from an inner side surface of the first sidewall 31_3 and has a shape corresponding to the shape of the upper surface 51_3 of the support member 50_3.

The support member 50_3 can be affixed more firmly by the inclusion of the second groove H2 with a first groove and a fixing portion 30P_3 of the mold frame 30_3.

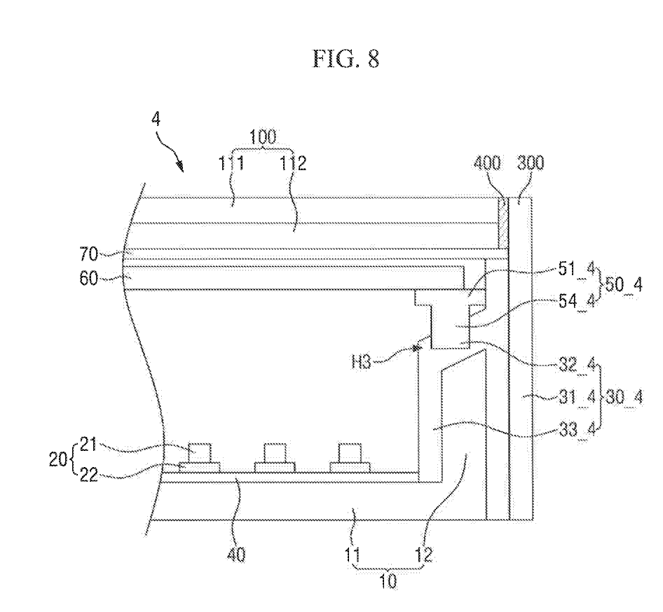

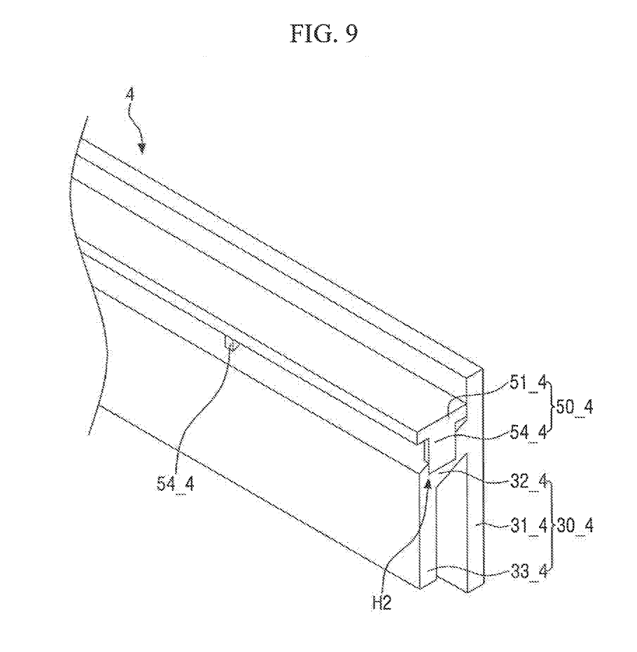

FIG. 8 is a cross-sectional view of a display device 4 according to an embodiment of the inventive concept. FIG. 9 is a partial perspective view of a mold frame 30_4 and a support member 50_4 of the display device 4 of FIG. 8.

Referring to FIGS. 8 and 9, the support member 50_4 of the display device 4 may have a fixing portion 54_4 shaped like a quadrilateral plate. The fixing portion 54_4 according to the this embodiment of the inventive concept is different from the pillar-shaped fixing portion 54_2 of the support member 50_2 shown in FIGS. 4 and 5.

The fixing portion 54_4 is provided in a plurality, and the fixing portions 54_5 are arranged at intervals along a side of an upper surface 51_4 of the support member 50_4 as shown. The fixing portion 54_4 may be shaped like a quadrilateral plate and inserted into a groove 113 formed in an inclined surface 32_4 of the mold frame 30_4. The amount of light reaching a display panel 100 from light sources 21 may increase as a thickness of the fixing portion 54_4, that is, a width of the fixing portion 54_4 in a long side direction of the upper surface 51_4 of the support member 50_4 is smaller.

As a breadth of the fixing portion 54_4, for example, a width of the fixing portion 54_4 in a short side direction of the upper surface 51_4 of the support member 50_4 increases, a larger area of the fixing portion 54_4 is affixed to the groove H3 of the mold frame 30_4. Therefore, the support member 50_4 can be affixed more stably to the mold frame 30_4. For example, since the support member 50_4 includes the fixing portion 54_4 having a reduced thickness and an increased width, it can be stably affixed to the mold frame 30 4 and minimize the loss of light reaching an edge portion of the display panel 100.

Although the width of the fixing portion 54_4 is smaller than a length of a short side of the upper surface 51_4 shown in the drawings, a person of ordinary skill in the art should understand and appreciate that the width of the fixing portion 54_4 and the length of the short side of the upper surface 51_4 can be substantially equal.

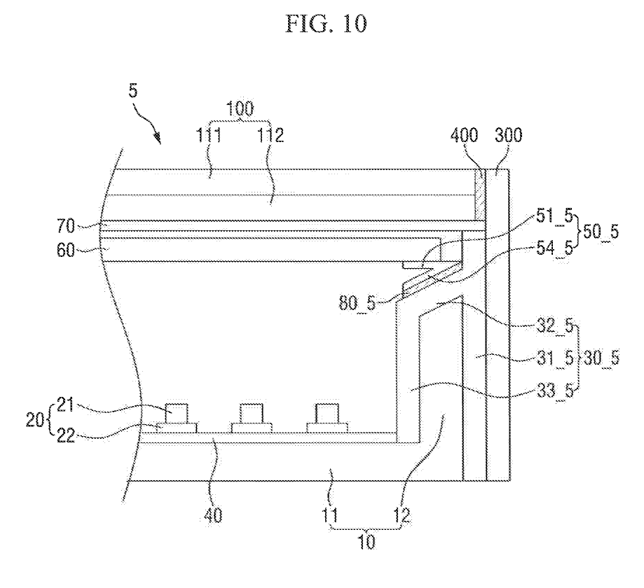

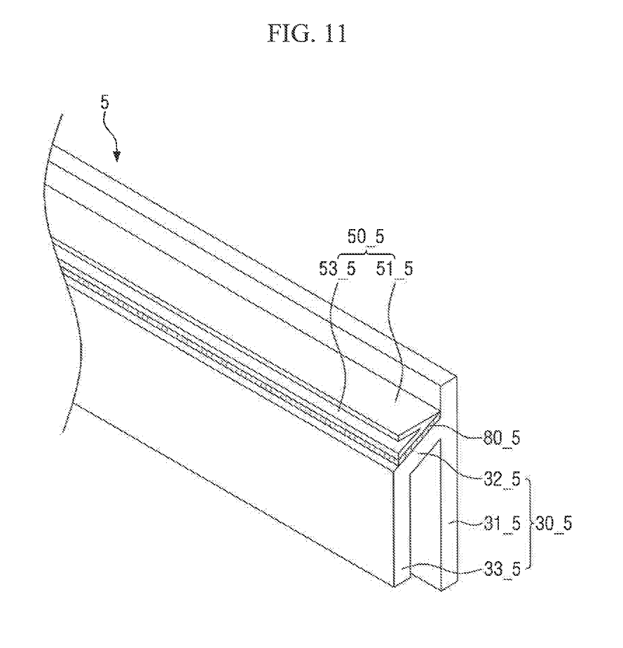

FIG. 10 is a cross-sectional view (if a display device 5 according to an embodiment of the inventive concept. FIG. 11 is a partial perspective view of a mold frame 30_5 and a support member 50_5 of the display device 5 of FIG. 10.

Referring to FIGS. 10 and 11, the support member 50_5 of the display device 5 may be shaped like a clamp. The support member 50_5 of the display device 5 differs, for example, from the support member 50 of the display device 1 of FIGS. 1 through 3 in that an empty space is formed between an upper surface 51_5 and an inclined surface 53_5 of the support member 50_5.

The support member 50_5 may include the upper surface 51_5 and the inclined surface 53_5. The inclined surface 53_5 slopes downward from an end of the upper surface 51_5. The angle formed by the upper surface 51_5 and the inclined surface 53_5 may be an acute angle.

Like the inclined surface 53 of the display device 1 of FIGS. 1 through 3, the inclined surface 53_5 may have the same inclination angle as that of an inclined surface 32_5 of the mold frame 30_5. For example, a downward inclination angle of the inclined surface 53_5 of the support member 50_5 may range from about 30 to 60 degrees.

Light emitted from light sources 21 may pass through the empty space between the upper surface 51_5 and the inclined surface 53_5 of the support member 50_5 to be incident on an edge portion of a display panel 100. Accordingly, the empty space formed between the upper surface 51_5 and the inclined surface 53_5 may serve as a light path that can reduce the loss of light and increase the amount of light incident on the edge portion of the, display panel 100. Accordingly, this structure can increase the luminance uniformity of the display panel 100 and reduce dark portions at the edge portion.

Experimentally confirmed reductions of dark portions at the edge portion of the display panel 100 according to the shapes of the mold frames 30, 30_2, 30_3, 30_4, and 30_5 of FIGS. 1 through 11, five display devices including mold frames of different shapes were prepared. First, as a comparative example, a mold flame that does not include an inclined surface, and that includes a first sidewall, an upper surface perpendicular to the first sidewall, and a second sidewall was prepared. In addition, a display device A (1) including the mold frame 30 of FIGS. 1 through 3, a display device B (2) including the mold frame 30_2 of FIGS. 4 and 5, a display device C (4) including the mold frame 30_4 of FIGS. 8 and 9, and a display device D (5) including the mold frame 30_5 of FIGS. 10 and 11 were prepared.

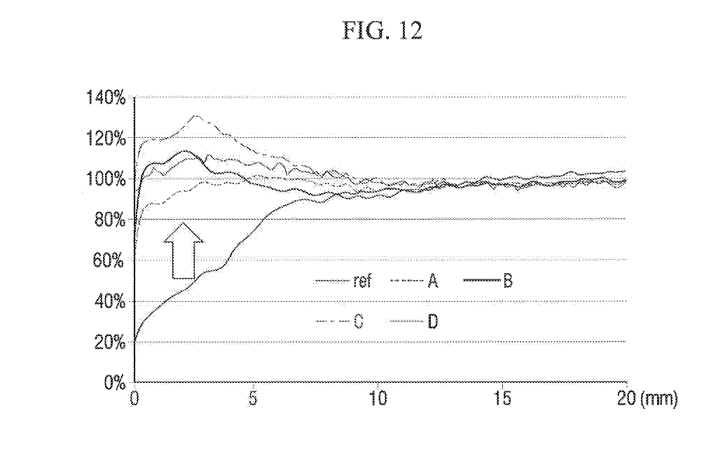

FIG. 12 is a graph illustrating luminance measured at an edge portion of each display device as discussed above in the preceding paragraph. In the graph of FIG. 12, the X-axis represents the distance from a side surface of a display device to a central portion of the display device, and a distance from 0 mm to about 10 mm indicates the edge portion of the display device. The Y-axis represents luminance, specifically, represents relative luminance at the edge portion when the luminance at the central portion of the display device is assumed as 100%.

Referring to FIG. 12, in the case of the comparative example, the luminance at the edge portion of the display device “ref” is about 20% to about 80% along the distance from 0 mm to about 10 mm, which is much lower than a luminance of 100% at the central portion. On the other hand, display devices A through D, which are display devices according to vari.ous embodiments of the inventive concept, have higher luminance at the edge portion than the display device “ref” of the comparative example.

Specifically, display devices A, B and D have a luminance of about 100% at the edge portion, which is similar to the luminance at the central portion. In addition, display device C has a luminance of about 120% at the edge portion, which is relatively greater than the luminance at the central portion. Consequently, it can be seen that the display devices 1, 2, 3, 4 and 5 including the mold frames 30, 30_2, 30_3, 30_4 and 30_5 according to the various embodiments of the inventive concept are effective in reducing dark portions at the edge portion.

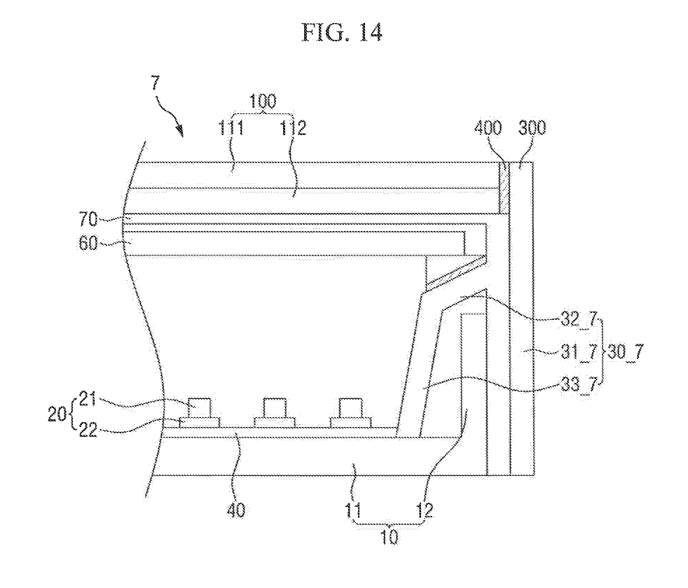

FIGS. 13 and 14 are cross-sectional views of display devices 6 and 7 according to embodiments of the inventive concept.

FIG. 13 shows that a mold frame 30_6 of the display device 6 includes an upper surface 34_6 and that an inclined surface (32a_6 and 32b_6) can be formed to have a double slope. FIG. 14 shows that a second sidewall 33_7 of a mold frame 30_7 of the display device 7 can he inclined.

Referring to FIG. 13, the mold frame 30_6 may include the upper surface 34_6, a first inclined surface 32a_6, and a second inclined surface 32h_6. A support member 50_6 may he supported by the upper surface 34_6_{Y} the first inclined surface 32a_6 and the second inclined surface 32b_6 of the mold frame 30_6.

The upper surface 34_6 of the mold flame 30_6 protrudes inward from an upper part of a first sidewall 31_6 and is perpendicular to the first sidewall 31_6 and parallel to a bottom surface 11 of a bottom cover 10. The first inclined surface 32a_6 slopes downward from an end of the upper surface 34_6, and the second inclined surface 32b_6 slopes downward from an end of the first inclined surface 32a_6.

A width d1 of the upper surface 34_6 of the mold frame 30_6, t which is a shortest distance from an inner side surface of the first sidewall 31_6 to a start point of the first inclined surface 32a_6 may be about 2 mm or less. When the width d1 of the upper surface 34_6 is about 2 mm or less, the upper surface 34_6 can stably support the support member 50_6 without interfering with the path of light traveling from light sources 21 toward an edge portion of a display panel 100.

In are embodiment of the inventive concept, the downward inclination angles θ1 and θ2 (enlarged view of FIG. 13) of the first inclined surface 32a_6 and the second inclined surface 32b_6 may be different from each other. The downward inclination angle θ1 of the first inclined surface 32a_6 with respect to the first sidewall 31_6 may be greater than the downward inclination angle θ2 of the second inclined surface 32b_6 with respect to the first sidewall 31_6. In other words, the first inclined surface 32a_6 may have a gentler (e.g., smaller, a less-steep) slope than the second inclined surface 32b_6. Since the weight of the support member 50_6 is dispersed on the first inclined surface 32a_6 having a smaller slope than the second inclined surface 32b_6, the support member 50_6 can be more stably affixed to the mold frame and supported as compared with when the support member 50_6 is disposed only on a steep slope. In addition, the light emitted from the light sources 21 may pass through a space between the relatively steep second inclined surface 32b_6 and an optical plate 60 to be incident on the edge portion of the display panel 100. Since the space between the optical plate 60 and the second inclined surface 32b_6 increases as the downward inclination angle θ2 of the second inclined surface 32b_6 is reduced, more light can pass through the space to be incident on the edge portion of the display panel 100.

When the support member 50_6 is supported by the upper surface 54_6 and/or the first inclined surface 32a_6, the downward inclination angle θ2 of the second inclined surface 32b_6 may be less than about 30 degrees.

In an embodiment of the inventive concept, the downward inclination angles θ1 and θ2 of the first inclined surface 32a_6 and the second inclined surface 32b_6 may be the same. In this case, the resultant inclined surface may be identical to the inclined surface 32 of the mold frame 30 of the display device 1 of FIGS. 1 through 3 but may additionally include the upper surface 34_6.

Referring now to FIG. 14, the second sidewall 33_7 of the mold frame 30_7 may extend at an angle to a bottom surface 11 of a bottom cover 10. The second sidewall 33_7 meets the bottom surface 11 with a downward inclination at an angle that is not perpendicular, whereas in other embodiments of the inventive concept, the downward inclination of the sidewall is substantially perpendicular to the bottom surface 11 of the bottom cover 10.

The second sidewall 33_7 may serve to reflect light emitted from light sources 21. Accordingly, the mold frame 30_7 may be made of a resin having excellent reflectivity, or a reflective material may be coated on an inner side surface of the second sidewall 33_7 of the mold frame 30_7. A downward inclination angle of the second sidewall 33_7 may be, for example, from about 30 to 60 degrees with respect to the bottom surface 11 of the bottom cover 10, so that the second sidewall 33_7 can have sufficient reflection efficiency.

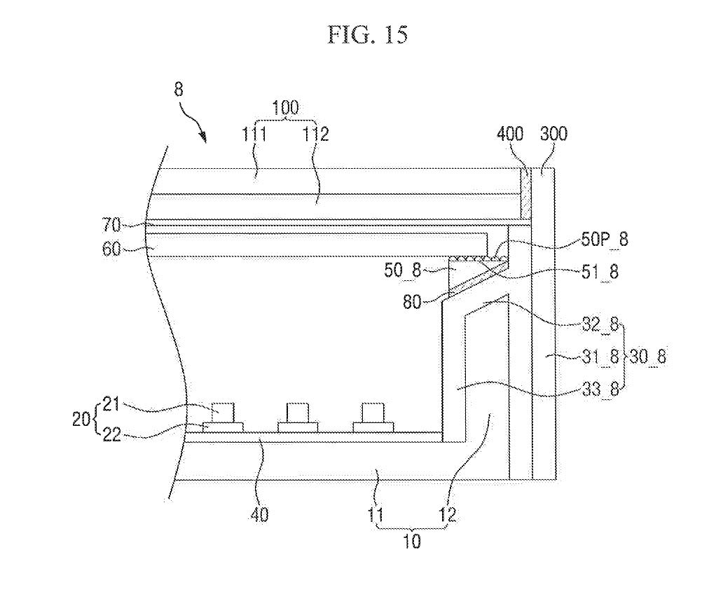

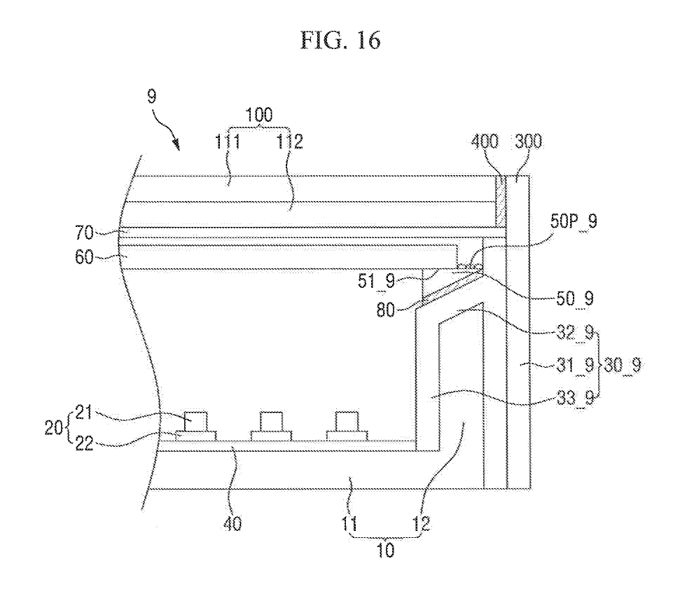

FIGS. 15 and 16 are cross-sectional views of display devices 8 and 9 according to embodiments of the inventive concept.

FIGS. 15 and 16 show that optical patterns 50P_8 and 50P_9 can be formed on respective upper surfaces 51_8 and 51_9 of respective support members 50_8 and 50_9 of the display devices 8 and 9.

Referring now to FIG. 15, the optical patterns 50P_8 may be disposed on the entire upper surface 51_8 of the support member 50_8. However, the optical patterns 50P_8 may not be disposed on the entire upper surface 51_8 of the support member 50_8. As illustrated in FIG. 16, the optical patterns 50P_9 may be disposed, for example, only on a portion of the upper surface 51_9 of the support member 50_9. In an embodiment of the inventive concept, the optical patterns 50P_9 may be disposed only in an area where the upper surface 51_9 of the support member 50_9 and an optical plate 60 do not overlap,

The optical patterns 50P_8 and 50P_9 may have a pattern shape that helps diffuse light. In the drawings, micro-lens patterns are formed as the optical patterns 50P_8 and 50P_9. However, the optical patterns 50P_8 and 50P_9 are not limited to the micro-lens patterns, and various patterns for diffusing light, for example, prism patterns and lenticular patterns, can be applied.

The optical patterns 50P_8 and 50P_9 may be formed of surface shapes of the support members 50_8 and 50_9. However, embodiments of the inventive concept are not limited to this case, and the optical patterns 50P_8 and 50P_9 may be formed b applying a resin on the upper surfaces 51_8 and 51_9 of the support members 50_8 and 50_9, or may be attached to the upper surfaces 51_8 and 51_9 in the form of a film.

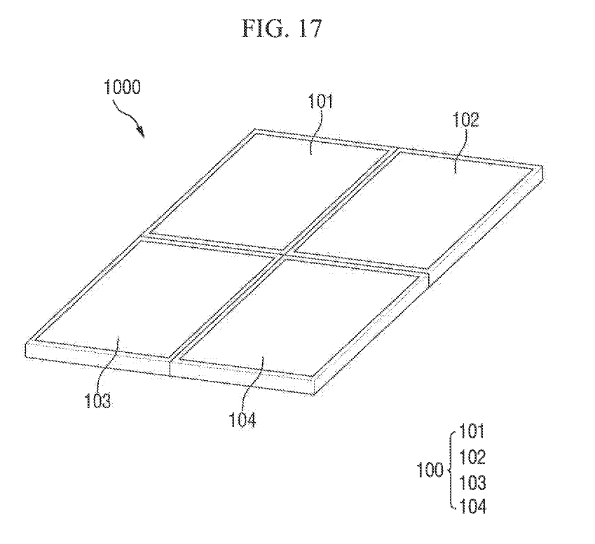

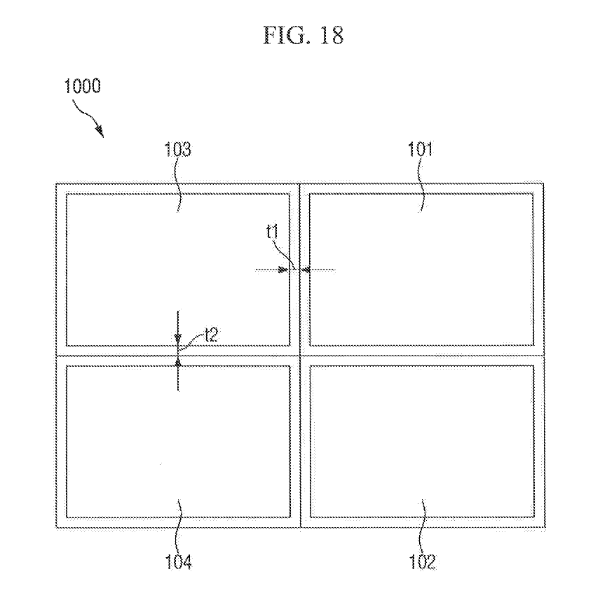

FIGS. 17 and 18 are a perspective view and a plan view of a multi-display device 1000 according to an embodiment of the inventive concept,

Referring to FIGS. 17 and 18, the multi-display device 1000 exemplifies that a plurality of display devices can be arranged in a matrix form. Any of the display devices 1 through 9 according to the above-described embodiments of the inventive concept may be applied to the multi-display device 1000.

A plurality of display devices may be arranged in a matrix of M×N, where M and N are natural numbers in the drawings, a plurality of display devices are arranged in a 2×2 matrix.

A plurality of display panels 101, 102, 103, and 104 may be connected together to display one image. For example, one image or video may be divided into four parts, and the four parts may be displayed on the display panels 101, 102, 103 and 104, respectively.

In each of the display devices constituting the multi-display device 1000 shown in plan view, a width t1 or t2 of a top cover 300 surrounding the display panels 101, 102, 103 and 104 is equal to a width of an upper surface of each sidewall of the top cover 300. In other words, in the multi-display device 1000 in FIGS. 17 and 18, the top cover 300 does not overlap an upper surface of each of the display panels 101, 102, 103 and 104 as described above, the width t1 or t2 of the top cover 300 may be the width of the upper surface of each sidewall of the top cover 300 in plan view. As the entire upper surfaces of the display panels 101, 102, 103 and 104 are exposed to the outside, a bezel area can be minimized.

In addition, in a case where the display devices 1 through 9 according to the above-described embodiments of the inventive concept are applied to the multi-display device 1000, dark portions at edge portions of the display panels 101, 102, 103 and 104 can be reduced, and the luminance uniformity of the whole of the display panels 101, 102, 103 and 104 can be increased.

In a display device according to an embodiment of the inventive concept, a space is secured between a mold frame and an optical plate. Therefore, the luminance at the edge of the display device can be increased, thereby increasing luminance uniformity.

However, the embodiments of the inventive concept are not limited to the ones set forth herein. The above and other effects of the embodiments of the inventive concept will be better appreciated by a person of ordinary skill in the art to which the embodiments pertain by referencing the claims.

What is claimed

1. A backlight unit comprising:
a light source;
a mold frame which accommodates the light source, the mold frame includes at least a first sidewall;
a support member disposed on the mold frame,
wherein the mold frame further includes an inclined surface protruding and sloping downward from an inner side surface of the first sidewall, and the support member is disposed on the inclined surface of the mold frame.

2. The backlight unit of claim 1, wherein the support member comprises an upper surface disposed substantially perpendicular to the first sidewall of the mold frame.

3. The backlight unit of claim 2, wherein the support member includes an inclined surface sloping downward, and the inclined surface of the support member has a same inclination angle as the inclined surface of the mold frame.

4. The backlight unit of claim 3, wherein a thickness of the support member increases when a distance from the first sidewall of the mold frame increases.

5. The backlight unit of claim 4, further comprising a joining member disposed between the support member and the inclined surface of the mold frame.

6. The backlight unit of claim 3, wherein the upper surface of the support member and the inclined surface of the support member are spaced apart from each other, providing an optical path in an empty space formed between the upper surface of the support member and the inclined surface of the support member.

7. The backlight unit of claim 2, further comprising:
a fixing portion that protrudes downward from the upper surface of the support member; and
a first groove formed in the inclined surface of the mold frame, wherein the fixing portion of the support member is affixed into the first groove of the mold frame.

8. The backlight unit of claim 7, further comprising a second groove formed in the first sidewall of the mold frame, wherein the upper surface of the support member is affixed into the second groove of the mold frame.

9. The backlight unit of claim 2, further comprising an optical plate disposed above the light source on the upper surface of the support member.

10. The backlight unit of claim 9, further comprising an optical sheet layer disposed above the light source on an upper surface of the first sidewall of the mold frame.

11. The backlight unit of claim 2, further comprising optical patterns disposed on the upper surface of the support member, wherein the optical patterns have a pattern shape to diffuse light.

12. The backlight unit of claim 2, wherein the mold frame further comprises at least one fixing portion which protrudes from an inner side surface of the first sidewall, wherein the at least one fixing portion of the mold frame is disposed higher than the inclined surface of the mold frame and contacts the upper surface of the support member to affix the support member to the mold frame.

13. The backlight unit of claim 1, wherein the support member is made of a transparent material.

14. The backlight unit of claim 13, wherein the support member includes scattering particles,

15. The backlight unit of claim 1, further comprising a bottom cover disposed under the light source, wherein the support member comprises an upper surface disposed substantially parallel to a bottom surface of the bottom cover.

16. The backlight unit of claim 1, wherein the inclined surface of the mold frame comprises a first inclined surface and a second inclined surface, wherein a second sidewall extends downward from the second inclined surface, and wherein the first inclined surface and the second inclined surface have different downward inclination angles.

17. A multi-display device comprising a plurality of display devices arranged in an M×N matrix in a first direction and a second direction substantially perpendicular to each other, wherein each of the display devices comprises:
a display panel; and
a backlight unit disposed under the display panel,
wherein the backlight unit comprises:
a light source including a plurality of lights;
a mold frame which accommodates the light source and the mold frame includes a first sidewall that extends downward and an inclined surface protruding and sloping downward from an inner side surface of the first sidewall, and a second sidewall that extends downward from the inclined surface of the mold frame, wherein the second sidewall is arranged substantially parallel to the first sidewall and having a space therebetween;
a support member disposed on the mold frame; and
an optical plate disposed on the support member,
wherein and the support member is disposed on the inclined surface of the mold frame.

18. The multi-display device of claim 17, wherein the support member includes an upper surface disposed substantially perpendicular to the first sidewall of the mold frame, and the optical plate is disposed on the upper surface of the support member.

19. The multi-display device of claim 17, wherein the support member is made of a transparent material.

20. The multi-display device of claim 17, further comprising a cover which covers side surfaces of the display panel and an outer side surface of the first sidewall of the mold frame, wherein the cover does not overlap an upper surface of the display panel.
